(19) United States
(12) Patent Application Publication
(10) Pub. No.: US 2011/0048911 A1
(43) Pub. Date: Mar. 3, 2011

(54) SLIDE TYPE MOVABLE CONTACTOR ASSEMBLY FOR CIRCUIT BREAKER

(75) Inventor: Su Yang SONG, Chungcheongbuk-Do (KR)

(73) Assignee: LS INDUSTRIAL SYSTEMS CO., LTD., Gyeonggi-Do (KR)

(21) Appl. No.: 12/858,696

(22) Filed: Aug. 18, 2010

(30) Foreign Application Priority Data
Sep. 1, 2009 (KR) 10-2009-0082177

(51) Int. Cl. H01H 3/02

(52) U.S. Cl. 200/337

(57) ABSTRACT

Disclosed is a slide type movable contactor for a circuit breaker with a slidable structure by which a contact pressure with the movable contactor is increased in a conduction state so as to minimize resistance and heat generation, the assembly including a movable contactor rotatable based upon a rotational shaft, connection plates configured to allow rotation of the movable contactor and simultaneously provide a conduction path by a contact with the movable contactor, and bimetal plates installed at side surfaces of the connection plates, respectively, and bends towards the connection plates in response to a temperature increase in a conduction state to press the connection plates so as to increase a contact pressure of the connection plates onto the movable contactor.

### CROSS-REFERENCE TO RELATED APPLICATION

Pursuant to 35 U.S.C. §119(a), this application claims the benefit of earlier filing date and right of priority to Korean Application No. 10-2009-0082177, filed on Sep. 1, 2009, the contents of which is incorporated by reference herein in its entirety.

### BACKGROUND OF THE INVENTION

1. Field of the Invention

The present invention relates to a circuit breaker, and particularly, to a slide type movable contactor assembly for a circuit breaker having a slidable contact structure between a movable contactor and conducting members.

2. Background of the Invention

In general, a circuit breaker or a molded case circuit breaker (MCCB) is an electric device which is installed at an electric power distributing line of a building, a factory, a ship or the like so as to open or close a normal circuit, automatically break a circuit upon occurrence of fault currents, such as electric shortage current, quickly extinguish arc generated, and handle relatively low voltages less than several hundreds of volt.

In the circuit breaker, in order to electrically connect a movable contactor to a terminal for connection with an external electric power source or electric load line (wire), a stranded wire made of flexible copper is typically used. Between electric connecting conductors with such stranded wire and the movable contactor, additional connecting conductors may be employed for rotatably supporting the movable contactor. There is a circuit breaker having a slide type movable contactor assembly having a structure, in which the movable contactor is inserted between two conductive connection plates and a rotational shaft is installed through the movable contactor and the connection plates such that the movable contactor slidably rubs against the connection plates during a circuit opening/closing operation, as the structure of connecting the additional connecting conductors and the movable contactor and simultaneously rotatably supporting the movable contactor. The present invention relates the slide type movable contact assembly for the circuit breaker.

In the related art slide type movable contactor assembly for the circuit breaker, in a circuit conduction state, namely, in a closed circuit state that a movable contactor comes in contact with a stationary contactor so as to supply electric power from an electric power source and an electric load, as the connection plates are more closely contacted to the movable contactor, a contact resistance is more lowered, thereby minimizing a heat generation and the thusly-caused temperature increase. However, in the slide type movable contactor, it is required that upon a circuit breaking operation, the movable contactor is allowed to be smoothly separated from the stationary contactor by being slidably rotated with respect to the connection plates.

Hence, preferably, the movable contactor is much strongly contacted with the connection plates in a conductive state, whereas slightly contacting the connection plates upon the circuit breaking operation for allowing the movable contactor to be smoothly slidable with rubbing against the connection plates.

However, in the related art, it was difficult to appropriately satisfy such antinomic requirements.

### SUMMARY OF THE INVENTION

The above mentioned object of the present invention can be achieved by providing a slide type movable contactor assembly for a circuit breaker, the assembly including a movable contactor rotatable based upon a rotational shaft, connection plates configured to allow rotation of the movable contactor and simultaneously provide a conduction path by a contact with the movable contactor; and bimetal plates installed at side surfaces of the connection plates, respectively, and curved towards the connection plates in response to a temperature increase in a conduction state to press the connection plates so as to increase a contact pressure of the connection plates onto the movable contactor.

Also, the object of the present invention may be achieved by providing a slide type movable contactor assembly for a circuit breaker, the assembly including a movable contactor rotatable based upon a rotational shaft, connection plates configured to allow rotation of the movable contactor and simultaneously provide a conduction path by a contact with the movable contactor, bimetal plates installed at side surfaces of the connection plates, respectively, and curved towards the connection plates in response to a temperature increase in a conduction state to press the connection plates so as to increase a contact pressure of the connection plates onto the movable contactor, a rotational shaft inserted through the connection plates, the bimetal plates and the movable contactor and providing a rotation support point to the movable contactor, and a connection base configured to connect the connection plates and the bimetal plates to each other by means of connecting means and support the same.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view diagonally showing down an assembled state of a slide type movable contactor assembly for a circuit breaker according to the present invention;

FIG. 2 is an exploded view of the slide type movable contactor assembly for the circuit breaker according to the present invention;

FIG. 3 is a partially enlarged view showing an operation of the slide type movable contactor assembly for the circuit breaker according to the present invention; and

FIG. 4 is an operational state view showing each of a conduction state and a state upon a breaking operation of the slide type movable contactor assembly for the circuit breaker according to the present invention.

### DETAILED DESCRIPTION OF THE INVENTION

The object of the present invention and the configuration and operational states to achieve the object of the present invention will be more definitely understood by description which will now be given in detail of the preferred embodiments according to the present invention, with reference to the accompanying drawings.

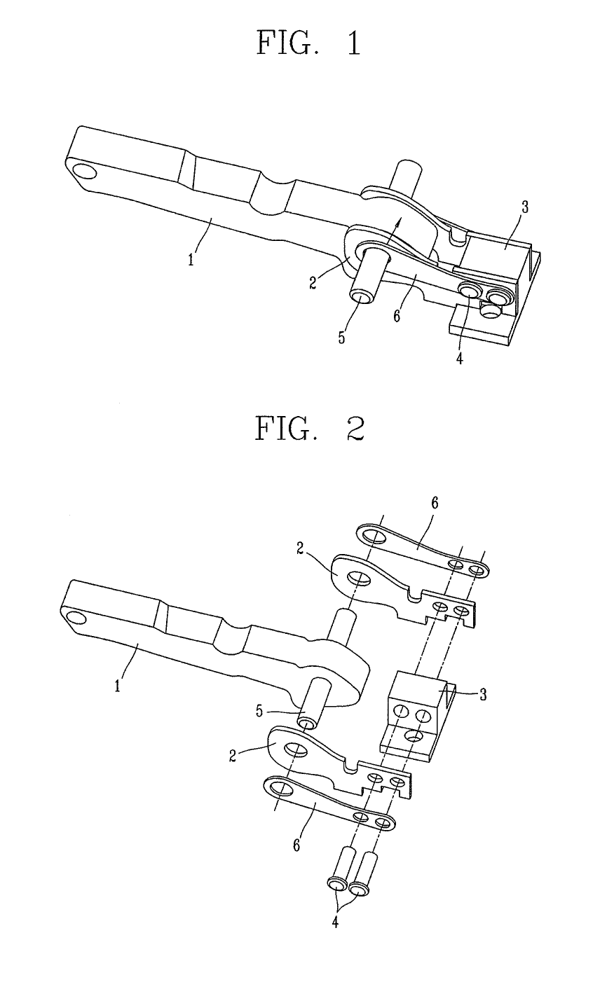

First, description will be given with reference to FIG. 1 which is a perspective view diagonally showing down an assembled state of a slide type movable contactor assembly for a circuit breaker according to the present invention, and FIG. 2 which is an exploded view of the slide type movable contactor assembly for the circuit breaker according to the present invention.

Referring to FIG. 1, a slide type movable contactor assembly for a circuit breaker according to the preferred embodiment of the present invention may comprise a movable contactor 1, connection plates 2 and bimetal plates 6. The slide type movable assembly for the circuit breaker according to the preferred embodiment of the present invention may further comprise a rotational shaft 5, a connection base 3 and a pair of connection rivets 4.

The movable contactor 1 may be rotatable, about the rotational shaft 5, to a circuit closing position where it contacts a corresponding stationary contactor (not shown) or a circuit opening position where it is separated from the stationary contactor. As well known, the rotation of the movable contactor 1 may be achieved by a manual manipulation using a manual manipulation handle, or by an automatic operation (i.e., a trip operation) using an elastic energy discharged by a trip spring of a switching mechanism in response to a trigger operation of a trip mechanism.

The connection plates 2 may be provided in pair, and located at both sides of the movable contactor 1 so as to allow rotation of the movable contactor 1 and simultaneously contact the movable contactor 1 to provide a conduction path. In other words, the pair of connection plates 2 are provided such that the movable contactor 1 can be interposed between the pair of connection plates 2 to be contactable with the same at its both side surfaces. Here, providing the conduction path indicates that a current flows via a stationary contactor (not shown), the movable contactor 1, the connection plates 2 and a stranded wire (not shown) as a conductor all electrically connected to, for example, an electrical power source of an electric power circuit, and then consequently flows via a terminal electrically connected to, for example, an electrical load of the electric power circuit, so as to allow electrical power supply. Therefore, the connection plates 2 may be made of a conductive material. Also, referring to FIG. 2, each of the connection plates 2 may include a through hole formed at a front end portion thereof for allowing insertion of the rotational shaft 5, and two rivet holes formed at a rear end portion thereof for allowing insertion of connection rivets 4, which secure the connection plates 2 with the connection base 3. Here, the present invention may not be limited to the configuration shown in this embodiment.

In the meantime, the bimetal plates 6, corresponding to a characteristic part of the present invention, may be installed at both side surfaces of the connection plates 2, respectively. The bimetal plates 6 are means for pressing the connection plates 2 by bending toward the connection plates 2, in response to an increase in a temperature in a conduction state, so as to increase a contact pressure of the connection plates 2 onto the movable contactor 1.

The bimetal plates 6 may be provided in pair and installed to be contactable with outer surfaces of the pair of connection plates 2, respectively. Hence, as the temperature increases more in the conduction state, the bimetal plates 6 press the connection plates 2 to be closely contacted to the movable contactor 1, thereby decreasing a contact resistance between the connection plates 2 and the movable contactor 1, resulting in prevention of a temperature increase due to the decrease of heat generation between the connection plates 2 and the movable contactor 1 in the conduction state. Consequently, the breakdown of the circuit breaker due to deterioration and melting of the movable contactor 1 or the connection plates 2 caused by the temperature increase and the thusly occurred severe damage on the circuit breaker can be prevented beforehand.

Still referring to FIG. 2, similar to the configuration of the connection plates 2, each of the bimetal plates 6 may include a through hole formed at a front end portion thereof for allowing insertion of the rotational shaft 5, and two rivet holes formed at a rear end portion thereof for allowing insertion of the connection rivets 4. Here, the present invention may not be limited to the configuration shown in this embodiment.

The rotational shaft 5 may be installed to be inserted through the front end portions of the pair of bimetal plates 6, the front end portions of the pair of connection plates 2 and a rear portion of the movable contactor 1. The rotational shaft 5 may also provide a rotation support point to the movable contactor 1. The length of the rotational shaft 5 may be decided to be greater than the sum of a thickness of the movable contactor 1, each thickness of the pair of connection plates 2 and each thickness of the pair of bimetal plates 6. Therefore, upon completely inserting the rotational shaft 5 through the movable contactor 1, the pair of connection plates 2 and the pair of bimetal plates 6, both end portions of the rotational shaft 5 may externally protrude from both outer side surfaces of the pair of bimetal plates 6.

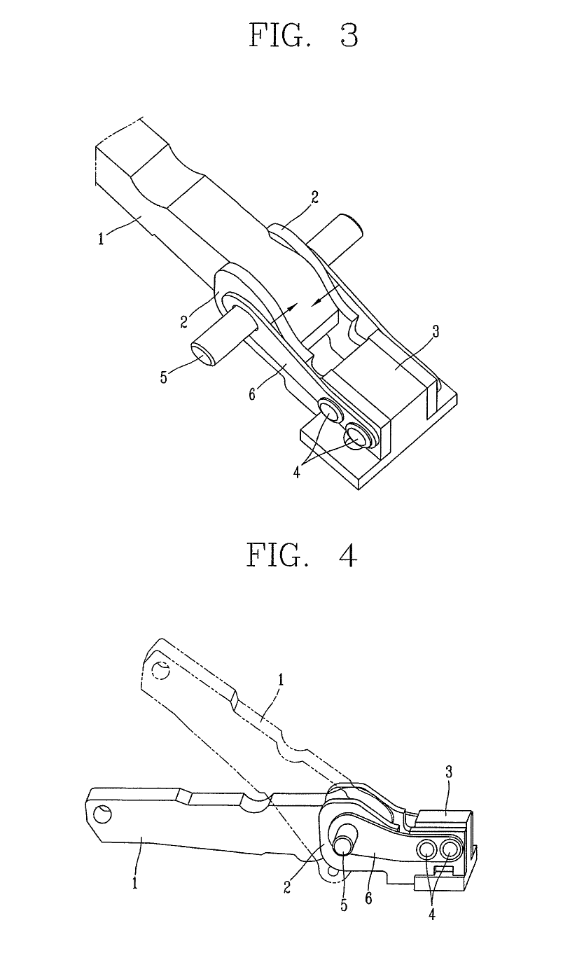

The connection base 3 may be provided for supporting the pair of bimetal plates 6 and the pair of connection plates 2. The connection base 3 may preferably be configured as an electric conductor, so it may be connectable with stranded wires which electrically connect the connection plates 2 to terminals (not shown), thereby creating a conduction path to the terminal sequentially via the movable contactor 1, the connection plate 2, the connection base 3 and the stranded wire. The connection base 3 may be secured with a lower surface of an outer case, typically made of an electrically insulating material, of the circuit breaker, by means of connecting means, such as screws. The connection base 3, referring to FIG. 3, may be provided with a pair of through holes for inserting a pair of connection rivets 4 therethrough.

The pair of connection rivets 4 may be used for allowing the connection plates 2 and the bimetal plates 6 to be supported by the connection base 3 at fixed positions. The pair of connection rivets 4 are inserted through the pair of through holes of the connection base 3 via the rivet holes of the connection plates 2 and the bimetal plates 6, and then both protruded end portions of the connection rivets 4 are pressed by a not shown pressing tool or a not shown pressing machine, thereby supporting the rear end portions of the connection plates 2 and the bimetal plates 6 to be closely contacted to the connection base 3.

Hereinafter, description will be given of a method of assembling the slide type movable contactor assembly for the circuit breaker having the configuration according to the present invention, with reference to FIG. 2.

First, the rotational shaft 5 is inserted through a shaft hole formed through a rear end portion of the movable contactor 1, to prepare an assembly of the movable contactor 1 and the rotational shaft 5.

Next, the rotational shaft 5, the pair of connection plates 2 and the pair of bimetal plates 6 are assembled by inserting the rotational shaft 5 through the front through holes of the pair of connection plates 2 and those of the pair of bimetal plates 6.

The pair of rivets 4 are inserted into the rear rivet holes of the pair of connection plates 2 and the pair of bimetal plates 6 and the through holes of the connection base 3. Afterwards, both protruded end portions of each rivet 4 are pressed the not shown pressing tool or the not shown pressing machine, thereby completely assembling the slide type movable contactor assembly for the circuit breaker according to the present invention.

Hereinafter, description will be given of an operation of the thusly configured slide type movable contactor assembly for the circuit breaker according to the present invention.

In a conduction state that the movable contactor 1 comes in contact with a stationary contactor (not shown), if a defective contact occurs between both side surfaces of the rear end portion of the movable contactor 1 and the pair of connection plates 2, then heat is generated due to the increase in a contact resistance between the side surfaces of the rear end portion of the movable contactor 1 and the pair of connection plates 2, and a temperature therebetween increases accordingly. Hence, referring the arrow shown in FIG. 3, as the temperature increases, the bimetal plates 6 installed to be contactable with the side surfaces of the connection plates 2 bends toward the connection plates 2, namely, in an internal direction. Accordingly, the bimetal plates 6 press the connection plates 2 such that the connection plates 2 are closely contacted to the movable contactor 1, thereby preventing the temperature increase between the side surfaces of the rear end portion of the movable contactor 1 and the pair of connection plates 2.

In the meantime, upon a trip operation (i.e., a circuit breaking operation), since a force that the movable contactor 1 rotates to be separated from the stationary contactor (not shown) in response to an elastic energy discharged by a trip spring (not shown) is much stronger than a frictional force which is generated when the pair of connection plates 2 are closely contacted to the side surfaces of the rear end portion of the movable contactor 1, referring to FIG. 4, the movable contactor 1 can be fast separated from the stationary contactor to break a circuit.

As described above, the slide type movable contactor assembly for the circuit breaker according to the present invention can employ bimetal plates, configured to press connection plates by bending toward the connection plates in response to a temperature increase due to heat generated between the movable contactor and the connection plates in a conduction state, whereby the temperature increase due to lowering of a contact pressure between the movable contactor and the connection plates in the conduction state can be minimized.

Also, the slide type movable contactor assembly for the circuit breaker according to the present invention can employ bimetal plates, configured to press connection plates by bending toward the connection plates in response to a the temperature increase due to heat generated between the movable contactor and the connection plates in a conduction state, accordingly, the failure of the circuit breaker due to deterioration, melting of the movable contactor or the connection plates caused by the temperature increase and the thusly occurred severe damage on the circuit breaker can be prevented beforehand.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A slide type movable contactor assembly for a circuit breaker comprising:
a movable contactor rotatable based upon a rotational shaft;
connection plates configured to allow rotation of the movable contactor and simultaneously provide a conduction path by a contact with the movable contactor; and
bimetal plates installed at both side surfaces of the connection plates, respectively, and bendable towards the connection plates in response to a temperature increase in a conduction state to press the connection plates so as to increase a contact pressure of the connection plates onto the movable contactor.

2. The assembly of claim 1, wherein the connection plates are provided in pair and installed to be contactable with both side surfaces of the movable contactor, respectively,
wherein the bimetal plates are provided in pair and installed to be contactable with outer surfaces of the connection plates, respectively.

3. The assembly of claim 1, further comprising:
a rotational shaft inserted through the connection plates, the bimetal plates and the movable contactor and providing a rotation support point to the movable contactor; and
a connection base configured to connect the connection plates and the bimetal plates to each other by means of connecting means and support the same.

4. The assembly of claim 3, wherein the connecting means comprises a rivet.
